(19) United States
(12) Patent Application Publication
(10) Pub. No.: US 2013/0130523 A1
(43) Pub. Date: May 23, 2013

(54) STRUCTURE OF LIFT COVER CONNECTOR

(71) Applicant: Chih-Cheng CHEN, Taoyuan Hsien (TW)

(72) Inventor: Chih-Cheng CHEN, Taoyuan Hsien (TW)

(73) Assignee: SPEED TECH CORP., TAOYUAN HSIEN (TW)

(21) Appl. No.: 13/366,356

(22) Filed: Feb. 6, 2012

(30) Foreign Application Priority Data
Nov. 18, 2011 (TW) 100221742

(51) Int. Cl. H01R 13/44

(52) U.S. Cl. 439/136

(57) ABSTRACT

An improved structure of a lift cover connector includes a base, a cover, a main body, a terminal module and a plurality of positioning members. The cover is rotatably pivoted to one end of the base, and the cover can be opened or closed relative to the base. The terminal module is received in the base, and is inserted and positioned in the main body. The base and the main body are engaged with each other, and the positioning members are inserted in the main body. This design enables the cover to automatically close the base in a normal state by a resilient function of the positioning members, thereby to facilitating reducing product loss and improving the overall yield.

### RELATED APPLICATIONS

This application claims priority to Taiwan Application Serial Number 100221742, filed Nov. 18, 2011, which is herein incorporated by reference.

### BACKGROUND

1. Field of Invention

This invention relates to a lift cover connector. More particularly, this invention relates to a RJ45 connector especially applicable to an Internet cable, wherein the lift cover connector has a rotatable cover, and the cover can be lifted for inserting a modular plug, and can be folded automatically when the lift cover connector is not in use.

2. Description of Related Art

Along with the progress of science technology, all kinds of new communication equipment have been presented to the market one after another under the requirements of easy operation method, powerful functions and thin and light volume for portability. However, these products need to use cables for transmitting and receiving electronic signals, so that a docking plug of the standard specification is usually used to be connected with the network cable, thereby enabling transmitting and receiving of signals.

The conventional electrical connector generally includes a plug-in surface matching with the size of the docking plug, an integrally formed insulating body and terminals received in the insulating body. However, as the height reserved by the insulating body for fitting the docking plug is too long, and particularly when the electrical connector is installed on a PCMCIA card, the entire volume of the PCMCIA card becomes too large, thus causing inconvenient storing and carrying for a user. Because of the volume of the insulating body, the installation site of the electrical connector in the portable equipment is restricted. Further, the plug-in surface is exposed externally, which may allow dust to adhere to the terminals easily, thus resulting in poor contact.

To solve the above problems, a lift cover electrical connector is designed by this industry. The lift cover electrical connector includes an insulating body and terminals received in the insulating body. The insulating body is in a two-piece style, and includes a base member and a cover member rotatably pivoted to the base member. When the cover member is lifted, the cover member and the base member form a plug-in surface for receiving the docking plug. When the docking plug is removed, the insulating body may be folded. Since the insulating body adopts the two-piece style, the entire height of a product can be reduced, thus improving the thinness and lightness of the product.

As shown in FIG. 9, U.S. Pat. No. 6,905,351 discloses an open/close type electrical connector. The open/close type electrical connector includes a base member A1, a terminal member A2 disposed on the base member A1 and a cover member A3 disposed above the base member A1. The front and rear sides of the cover member A3 and the base member A1 are combined by an interlock device. The cover member A3 can be moved horizontally relative to the base member A1 for performing open/close actions. An accommodation space (not labeled in the figure) is formed between the base member A1 and the cover member A3 for containing a modular plug A20. The cover member A3 is moved in parallel, that is, whatever the cover member A3 is in an open state or close state which can be paralleled the base member A1.

The interlock device at the rear side of the electrical connector is a connecting rod A51, and the interlock device at the front side of the electrical connector is an elastic component A41. When the cover member A3 is in an open state, the elastic component A41 accumulates a resilient force. When the modular plug A20 is removed out of the containing space (not marked in the figure) formed between the cover member A3 and the base member A1, the cover member A3 may automatically close the base member A1 under the resilient force of the elastic component A41. Since the electrical connector makes the cover member A3 stay at the open or close positions (up or down positions) by fitting and positioning two engagement points of the connecting rod A51 and the elastic component A41, the engagement failure usually happens to the engagement points due to the abrasion after the long-term of use, and the cover member A3 may assume the fixed shut state and lose the functions. Therefore, it is necessary to improve the design.

### SUMMARY

This invention provides an improved structure of a lift cover connector, which enables the lift cover connector to be used repetitively without easily causing plug-in function failure, thus effectively improving product yield and reducing its entire volume, so that the lift cover connector is thin and light when being installed on an electronic device, thereby meeting the thinness and lightness and chic requirements of multimedia products.

The improved structure of the lift cover connector disclosed in this invention includes a base, a cover, a main body, a terminal module and a plurality of positioning members. The cover is rotatably pivoted to one end of the base, and the cover may open or close relative to the base. When the cover is pulled open downwardly, a side edge of the cover slides down along a side surface of the base, and resists against a rear edge of the front wall of the base, and at the same time the front end of the cover is rotated to be open and thus an opening is formed. The terminal module is received in the base, and is inserted and positioned in the main body. The front edge of each of the left and right walls of the base has a buckling block, and the main body has an elongated slot at a position corresponding to the buckling block. The elongated slot may be pushed upwardly along the front edge of the left or right wall of the base, and further engaged with the buckling block, so that the base and the main body are engaged with each other and securely assembled on a circuit board. The positioning members are respectively inserted in the main body, and under the resilient function of each of the positioning members, the cover is enabled to automatically close the base in a normal state, so as to reduce the entire height of the lift cover connector.

Each of the positioning members in this invention has a base portion. One end of the base portion is bent and extends to form a connecting portion. The connecting portion extends upwardly in a parallel asymptote manner to form an elastic arm. A free end of the elastic arm has a sliding block. The sliding block is slidably positioned in a movable slot of the cover. Under the compression elastic force formed by the connecting portion and the elastic arm, the sliding block can be positioned and moved back and forth in the movable slot. The base portion has a buckling portion opened at the middle thereof. The main body has a slot hole corresponding to the base portion. When the base portion is inserted in the slot hole, the buckling portion can be buckled and retained in the hollow portion of the slot hole, so that the base portion can be positioned in the slot hole. In addition, an accommodation cavity is formed in the opening at the front end of the cover and a hollow portion of the base. The accommodation cavity can be used for receiving a docking plug. A pivotal axis is protrusively disposed at a rear end of the cover, and enables the cover to be rotatably pivoted to the base. The base includes a front wall, a rear wall and left and right walls respectively connected to the front wall and the rear wall. Pivoting holes are recessed corresponding to the pivotal axis on an inner side of left and right walls. When the cover is pulled open downwardly, the compressed points of the pivotal axis are deviated from an axis of the pivoting holes to make the cover rotate downwardly and is resisted open by the docking plug for allowing the docking plug be inserted therein. When the docking plug is withdrawn, the positioning member forms the compression elastic force on the cover, so that the cover is persistently compressed by the connecting portion and the elastic arm, and the cover rotates upwardly and returns to be fit to the base. Positioning portions are recessed at the same positions on two sides of the base and the main body respectively. Each of the positioning portions may respectively accommodate a positioning piece. The positioning piece perpendicularly penetrates the base and the main body and is inserted in the circuit board. The terminal module includes an insulating main body and a plurality of terminals located in the insulating body. Retaining portions are respectively disposed on two sides of the insulating body. A terminal slot is recessed on the base opposite to the accommodation cavity for respectively receiving a plurality of terminals. Elongated sliding slots are recessed on left and right sides of the terminal slot. The retaining portions may enter the base through the sliding slots, so as to make the terminal module received in the base.

This invention also provides an improved structure of a lift cover connector. The pivot has a plastic rim, and the base has an elastic plastic plate. The elastic plastic plate has a plastic indentation corresponding to the plastic rim. When the cover is pulled open downwardly, the plastic rim is rotated to a stopping point at the same time to form a friction interference positioning with the plastic indentation. When the cover is pulled upwardly, the plastic indentation generates an elastic deformation. The plastic rim is indirectly disengaged from the stopping point, so as to make the cover rotated to close the base.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective appearance view of a first embodiment of this invention after being assembled;

FIG. 2 is a perspective appearance view of the first embodiment of this invention viewed from another viewing angle;

FIG. 3 is a three-dimensional exploded view of the first embodiment of this invention;

FIG. 4 is a three-dimensional exploded view of the first embodiment of this invention viewed from another viewing angle;

FIG. 5 is a perspective profile view of the first embodiment of this invention in an open state;

FIG. 6 is a perspective profile view of the first embodiment of this invention in a close state;

FIG. 7 is a three-dimensional exploded view of a second embodiment of this invention;

FIG. 8 is a three-dimensional exploded view of the second embodiment of this invention viewed from another viewing angle; and

FIG. 9 is a three-dimensional exploded view of U.S. Pat. No. 6,905,351.

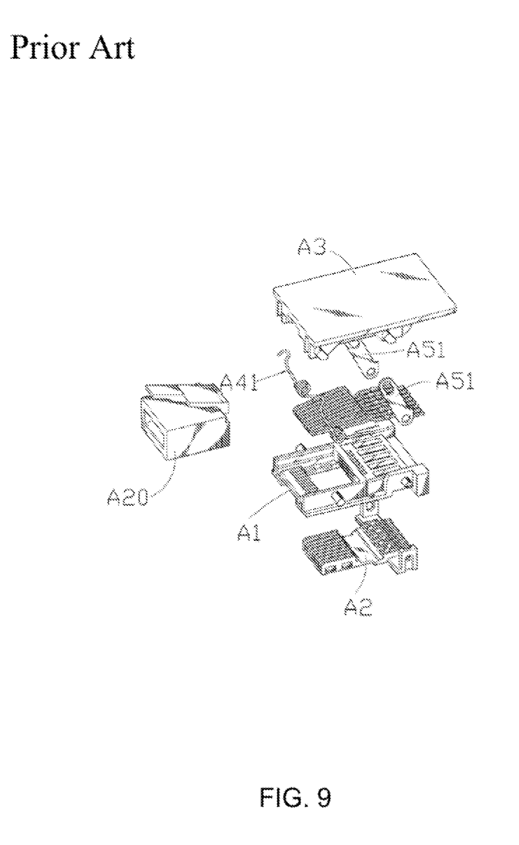

### DETAILED DESCRIPTION

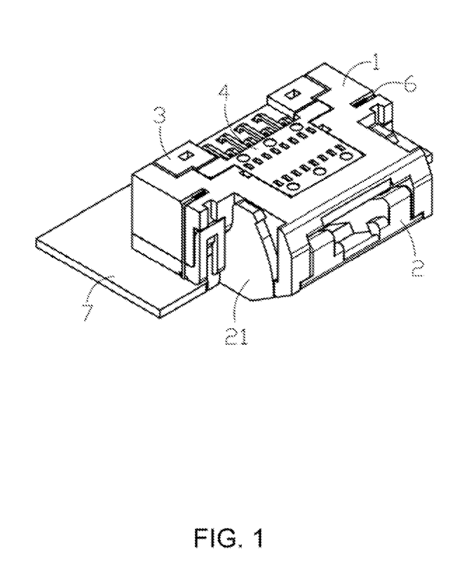

FIG. 1 to FIG. 3 illustrate an improved structure of a lift cover connector of this invention. The improved structure of the lift cover connector mainly includes a base 1, a cover 2, a main body 3, a terminal module 4 and a plurality of positioning members 5. The cover 2 is rotatably pivoted to one end of the base 1, and the cover 2 can be opened or closed relative to the base 1. When the cover 2 is pulled open downwardly, a side edge 21 of the cover 2 slides downwards along a side surface 11 of the base 1. When sliding downwards for an angle, an engaging block 22 at the top end of the side edge 21 of the cover 2 can resist against the rear edge of the front wall 12 of the base 1. At the same time, the front end 23 of the cover 2 rotates to be unfolded and form an opening 24. The terminal module 4 is received in the base 1, and is inserted and positioned in the main body 3. The front edge of each of the left and right walls 13 of the base 1 have a buckling block 14 and a stopping portion 15 at a certain distance from the buckling block 14. The main body 3 has an elongated slot 31 at the corresponding position of the buckling block 14. The elongated slot 31 can be pushed upwardly towards the stopping portion 15 along the front edge of the left and right walls 13 of the base 1, and further respectively engaged with the buckling block 14, so that the base 1 and the main body 3 are engaged with each other and securely assembled on a circuit board 7. The positioning members 5 are respectively inserted in the main body 3, and under the compression resilient function of each of the positioning members 5, the cover 2 is enabled to automatically close the base 1 in a normal state, so as to reduce the entire height of the lift cover connector and reduce the entire thickness of the lift cover connector.

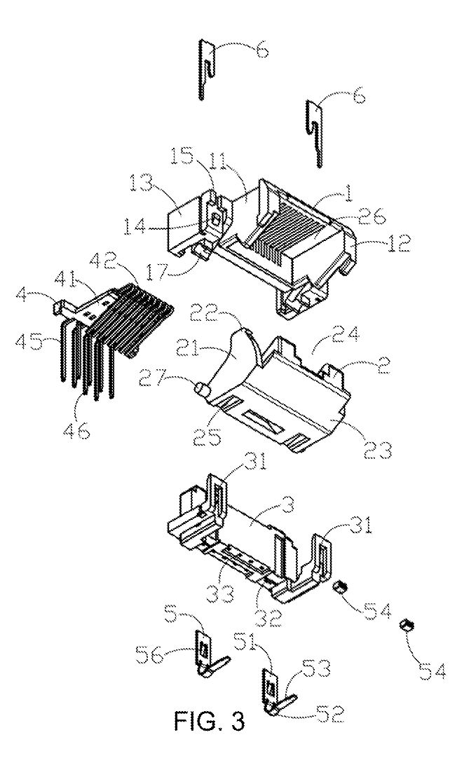

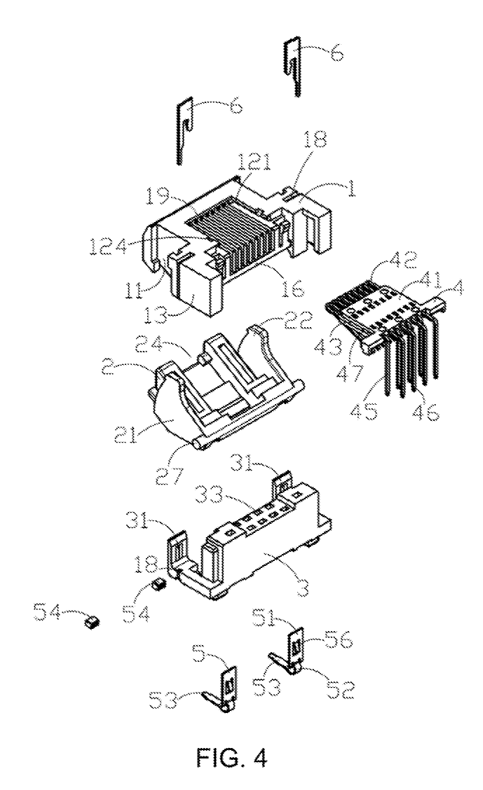

As shown in FIG. 3 and FIG. 4, in the first embodiment of this invention, each of the positioning members 5 has a rectangular flat base portion 51. One end of the base portion 51 is bent and extends to form an inverted hook-shaped connecting portion 52. One end of the connecting portion 52 located away from the base portion 51 extends upwardly in a parallel ‘asymptote manner to form an elastic arm 53. A free end of the elastic arm 53 has a sliding block 54, and the sliding block 54 can be movably positioned in a movable slot 25 of the cover 2. When the cover 2 is opened or closed relative to the base 1, under a compression elastic force formed by the connecting portion 52 and the elastic arm 53, the sliding block 54 can be positioned and moved back and forth in the movable slot 25, thereby restricting the cover 2 to be opened or closed in sync. The base portion 51 has a buckling portion 56 opened in the middle thereof. The main body 3 has a slot hole 32 corresponding to the base portion 51. When the base portion 51 is inserted in the slot hole 32, the buckling portion 56 can be buckled and retained in the hollow portion of the slot hole 32, so that the base portion 51 can be interference positioned in the slot hole 32. In addition, an accommodation cavity 26 is formed in the opening 24 formed at the front end 23 of the cover 2 and a hollow portion of the base 1. The accommodation cavity 26 can accommodate a docking plug (not labeled in the figure). Some gaps are left between the opening 24 of the front end 23 of the cover 2 and the left and right side edges 21 for receiving the left and right side surfaces 11 of the base 1. A pivotal axis 27 is protrusively disposed at the rear end of the cover 2, and enables the cover 2 to be rotatably pivoted to the base 1.

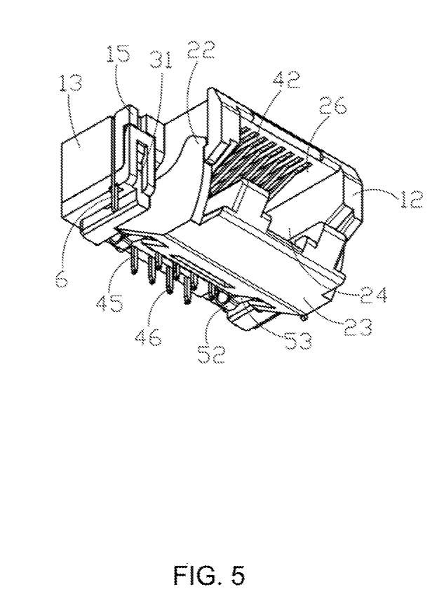

As shown in FIG. 3 to FIG. 5, in the first embodiment of this invention, the base 1 includes a front wall 12, a rear wall 16 and left and right walls 13 respectively connected to the front wall 12 and the rear wall 16. Pivoting holes 17 are recessed on the inner sides of the left and right walls 13 corresponding to the pivotal axis 27. When the cover 2 is desired to move from the close state to the open state, only a downward force is needed to be applied on the cover 2, so that when the cover 2 is pulled open downwardly, the compressed point of the pivotal axis 27 may be deviated from the axis of the pivoting hole 17 to make the cover 2 rotate downwardly. At the same time, the side edge 21 of the cover 2 slides downward along the side surface 11 of the base 1. When sliding for an angle, an engaging block 22 at the top end of the side edge 21 of the cover 2 can resist against the rear edge of the front wall 12 of the base 1. The cover 2 can be restricted and does not move again, and meanwhile, the docking plug (not marked in the figure) can be inserted in the accommodation cavity 26 formed in the hollow portion of the base 1 and the opening 24 of the cover 2. The cover 2 is resisted open by the docking plug (not labeled in the figure) to make the docking plug (not labeled in the figure) contact and electrically conduct with the terminal module 4, so as to transmit or receive electrical signals.

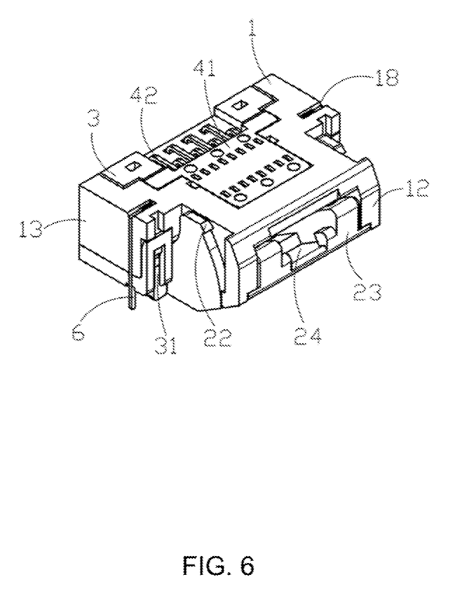

As shown in FIG. 4 to FIG. 6, in the first embodiment of this invention, when the docking plug (not marked in the figure) is withdrawn, the cover 2 is not supported by the docking plug (not labeled in the figure), and does not apply any force on the cover 2. The positioning member 5 forms an elastic resilient force on the cover 2, so that the cover 2 is persistently compressed by the connecting portion 52 and the elastic arm 53, and the cover 2 spins upwardly and returns to be fit to the base 1. Positioning portions 18 are recessed at the same positions on two sides of the base 1 and the main body 3 respectively. Each of the positioning portions 18 can accommodate a positioning piece 6. The positioning piece 6 perpendicularly penetrates through the base 1 and the main body 3 and is inserted in the circuit board (not labeled in the figure).

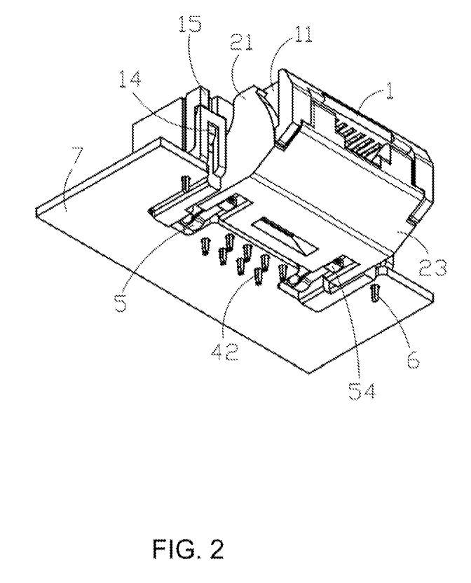

As shown in FIG. 2 to FIG. 4, in the first embodiment of this invention, the terminal module 4 includes an insulating body 41 and a plurality of terminals 42 located in the insulating body 41. Retaining portions 43 are respectively disposed on two sides of the insulating body 41. A terminal slot 19 is recessed on the base 1 opposite to the accommodation cavity 26 for respectively receiving the terminals 42. One end of each of the terminals 42 located away from the insulating body 41 respectively extends perpendicularly downwardly to form a plug-in portion 45. The plug-in portion 45 may sequentially penetrate through a plurality of plug-in holes 33 of the main body 3 according to the arrangement sequence of the terminals 42, so as to be forced-positioned. The bottom end of the plug-in portion 45 of the terminals 42 respectively has a welding pin 46. The welding pin 46 may be electrically connected to the circuit board 7. Elongated sliding slots 121 are respectively recessed on the left and right sides of the terminal slot 19. The retaining portion 43 may enter the base 1 through the sliding slots 121 to make the terminal module 4 received in the base 1. The retaining portion 43 has an engaging edge 47 at the proper position. Each of the sliding slots 121 has a notch 124 corresponding to the engaging edge 47. When the retaining portion 43 enters the base 1 through the sliding slots 121, the engaging edge 47 can be stopped and positioned in the notch 124, so as to prevent the retaining portion 43 from being displacing forwards and backwards.

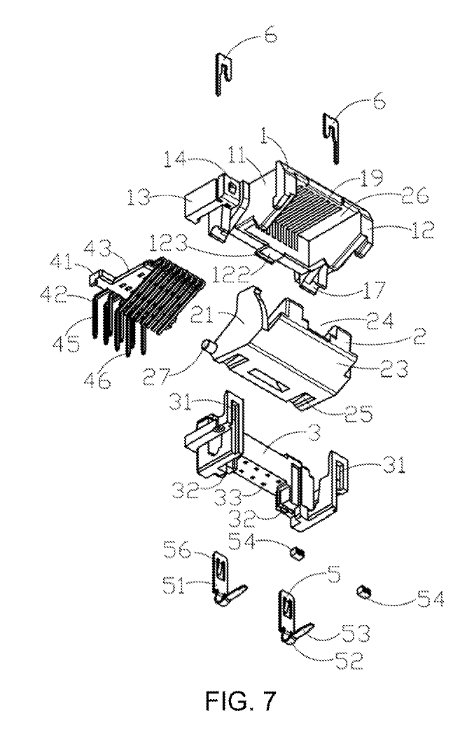

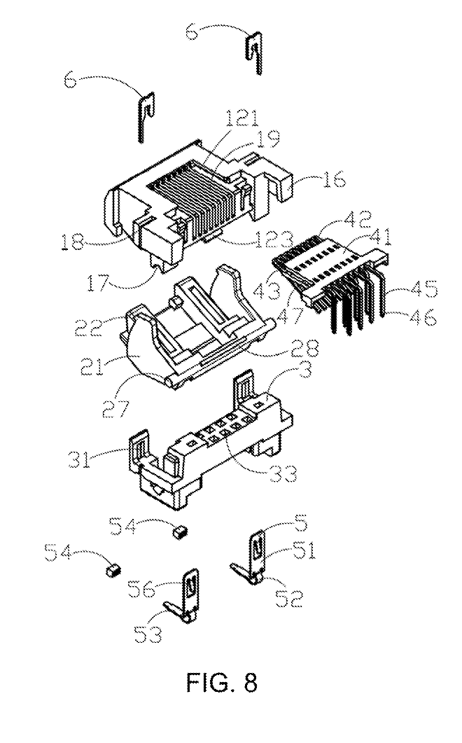

As shown in FIG. 7 and FIG. 8, in the second embodiment of this invention, a semi-cylindrical plastic rim 28 is disposed above the pivotal axis 27. An elastic plastic plate 122 is disposed below the base 1. The elastic plastic plate 122 has a plastic indentation 123 corresponding to the plastic rim 28. When the cover 2 is desired to move from the close state to the open state, the downward force is needed to be applied on the cover 2 to pull open the cover 2 downwardly. The plastic rim 28 rotates approaching a stopping point and is engaged with the plastic indentation 123, so as to form a friction interference positioning therebetween, thus inserting the docking plug (not labeled in the figure) in the accommodation cavity 26. When the docking plug (not labeled in the figure) is withdrawn, the plastic rim 28 and the plastic indentation 123 are still engaged and positioned with each other. An upward force is needed to be applied on the cover 2, so that when the cover 2 moves upwardly, the plastic indentation 123 generates the elastic deformation, and the plastic rim 28 is indirectly disengaged from the stopping point, so as to make the cover 2 rotate to close the base 1.

It can be known from the description of the aforementioned structure that, the improved structure of the lift cover connector of this invention can be folded into a thin object when not being in use, and does not need a large operation space. Therefore, the improved structure of the lift cover connector of this invention completely meets the requirement of repetitive use without generating the problem of the plug-in function failure easily and occupying a large space, thereby meeting the requirement of smallness and lightness and portability.

In view of the above, the improved structure of the lift cover connector of this invention actually achieves the efficacy by the improved structure disclosed above. Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. An improved structure of a lift cover connector, comprising a base, a cover, a main body, a terminal module and a plurality of positioning members, wherein the cover is rotatably pivoted to one end of the base and is configured to be opened or closed relative to the base, and the terminal module is received in the base and is inserted and positioned in the main body, and the base and the main body are engaged with each other, and are securely assembled on a circuit board, and the improved structure of a lift cover connector is characterized in that the positioning members are respectively inserted in the main body, and by a resilient function of each of the positioning members, the cover is enabled to automatically close the base in a normal state.

2. The improved structure of the lift cover connector of claim 1, wherein each of the positioning members has a base portion, and one end of the base portion is bent and extends to form a connecting portion.

3. The improved structure of the lift cover connector of claim 2, wherein the connecting portion extends upwardly in a parallel asymptote manner to form an elastic arm, and a free end of the elastic arm has a sliding block, and the sliding block is slidably positioned in a movable slot of the cover.

4. The improved structure of the lift cover connector of claim 2, wherein the base portion has a buckling portion disposed in the middle thereof, and the main body has a slot hole corresponding to the base portion, and when the base portion is inserted in the slot hole, the buckling portion is buckled and retained in the slot hole.

5. The improved structure of the lift cover connector of claim 1, wherein an opening is recessed on a front end of the cover, an accommodation cavity is formed in a hollow portion between the opening and the base, and a pivotal axis is protrusively disposed at a rear end of the cover.

6. The improved structure of the lift cover connector of claim 5, wherein the base comprises a front wall; a rear wall, and left and right walls respectively connected to the front wall and the rear wall, and pivoting holes are recessed corresponding to the pivotal axis on inner sides of the left and right walls.

7. The improved structure of the lift cover connector of claim 1, wherein positioning portions are recessed at the same positions on two sides of the base and the main body respectively, and each of the positioning portions respectively accommodates a positioning piece, and the positioning piece perpendicularly penetrates through the base and the main body and is inserted in the circuit board.

8. The improved structure of the lift cover connector of claim 1, wherein the terminal module comprises an insulating body and a plurality of terminals located in the insulating body, and retaining portions are respectively disposed on two sides of the insulating body, and a terminal slot is recessed on the base opposite to the accommodation cavity for respectively receiving the terminals, and elongated sliding slots are recessed on left and right sides of the terminal slot, and the retaining portions enter the base through the sliding slots, so as to make the terminal module received in the base.

9. The improved structure of the lift cover connector of claim 6, wherein the pivot has a plastic rim, and the base has an elastic plastic plate, and the elastic plastic plate has a plastic indentation corresponding to the plastic rim.

10. The improved structure of the lift cover connector of claim 9, wherein when the cover is pulled open downwardly, the plastic rim rotates to a stopping point to form a friction interference positioning with the plastic indentation.

11. The improved structure of the lift cover connector of claim 9, wherein when the cover is pulled upwardly, the plastic indentation generates an elastic deformation, and the plastic rim is indirectly disengaged from the stopping point, so as to make the cover rotated to close the base.
